(19) United States
(12) Patent Application Publication
(10) Pub. No.: US 2006/0242620 A1
(43) Pub. Date: Oct. 26, 2006

(54) Method for maintaining and selling software

(75) Inventors: Paresh J. Malde, Okemos, MI (US); Anand Uday, Lansing, MI (US); Abhishek Jha, Lansing, MI (US); Saaj M. Shah, E. Lansing, MI (US)

Correspondence Address: CLARK HILL, P.C., 500 WOODWARD AVENUE, SUITE 3500, DETROIT, MI, 48226, US

(73) Assignee: Avadhi Finance & Technology, Okemos, MI (US)

(21) Appl. No.: 11/112,453

(22) Filed: Apr. 22, 2005

(51) Int. Cl. G06F 9/44

(52) U.S. Cl. 717/104

(57) ABSTRACT

A method for subscribing to a portion of a plurality of software modules allows a subscriber to have access to the portion of the plurality of software modules. The method includes the steps of identifying the subscriber, providing the plurality of software modules to the subscriber and receiving the selections from the subscriber. The method then associates each of the selections with the portion of the plurality of software modules. Each of the portion of plurality of software modules is then tagged to correlate the portion of the plurality of software modules to the subscriber. The method then stores these tags such that the subscriber can access the portion of the plurality of software modules when desired.

### BACKGROUND ART

1. Field of the Invention

The invention relates to a method for maintaining and selling to software modules within a program hierarchy. More specifically, the invention relates to a method for providing software and updating software selections in a manner that is consistent for the client across all locations.

2. Description of the Related Art

The internet provides a vast opportunity to retrieve and assimilate information. If a user of the internet is not organized, the information may be overwhelming. To help in organizing the information for users, there are several websites designed organizationally to help a visitor at the website to navigate through the offering of the website to maximize the information gathering results for that visitor.

Software is used to perform many functions. As the software is assimilated by users, comfort in its use grows. And as users become more familiar with a software package, desires for missing functionality and features grows. Those that develop software and are intimately involved in computer functionality find the challenge of making software better an effort worthy of their time. Additions to software, e.g., software modules, find their way into commercial channels allowing more than just the creator the opportunity to enjoy the new functionality. Regardless of whether the software is created for such popular titles as Microsoft® Excel™ or whether the software is dedicated to a few elite scientists scattered across the world, they are developed in a manner that will always invite additions and modifications thereto.

As time progresses, a user's needs may change which will result in the user finding a particular software package of lesser value or no value. While the overall software package may be fine, additions or subtractions to and from the software package may provide greater value to the user. The incorporation of these modules or smaller software packages that dovetail into the overall software scheme will maintain a user finding great value in the software package.

Currently, options available to users are limited to communicating with the software provider through unrelated correspondence techniques to convey an interest to the software provider that additions or subtractions to the overall software package are needed. This results in substantial “downtime” preventing the user of the software to do exactly what he or she requires.

Even if a software package or a subscription thereto could be modified immediately, there are issues with the relevant art relating to the synchronization of the changes in the software subscription should the user be operating the system from several locations. Therefore, there is a need a in the art for a method for automatically changing a subscription of a software package and providing that newly updated subscription to all locations in which the software is used.

### SUMMARY OF THE INVENTION

A method for subscribing to a portion of a plurality of software modules allows a subscriber to have access to the portion of the plurality of software modules. The method includes the steps of identifying the subscriber, providing the plurality of software modules to the subscriber and receiving the selections from the subscriber. The method then associates each of the selections with the portion of the plurality of software modules. Each of the portion of plurality of software modules is then tagged to correlate the portion of the plurality of software modules to the subscriber. The method then stores these tags such that the subscriber can access the portion of the plurality of software modules when desired.

### BRIEF DESCRIPTION OF THE DRAWINGS

Advantages of the invention will be readily appreciated as the same becomes better understood by reference to the following detailed description when considered in connection with the accompanying drawings, wherein:

FIGS. 1 through 3 represent logic diagrams of three portions of one embodiment of the invention method;

FIG. 4 is a screen shot presented by the inventive method summarizing a subscription of a module configuration selected by a user; and

FIG. 5 is a representation of code incorporated into the invention.

### DETAILED DESCRIPTION OF THE PREFERRED EMBODIMENT

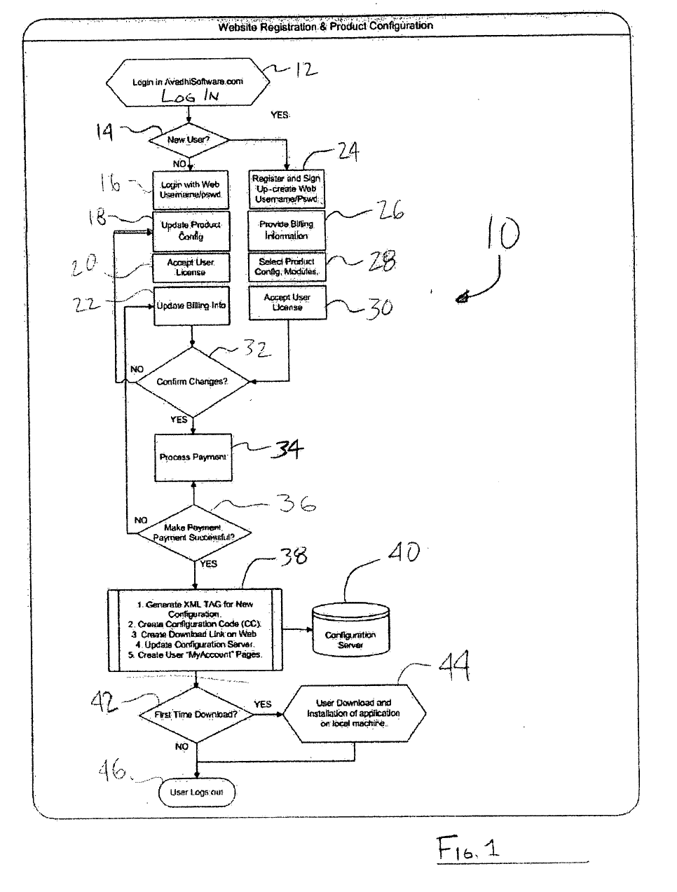

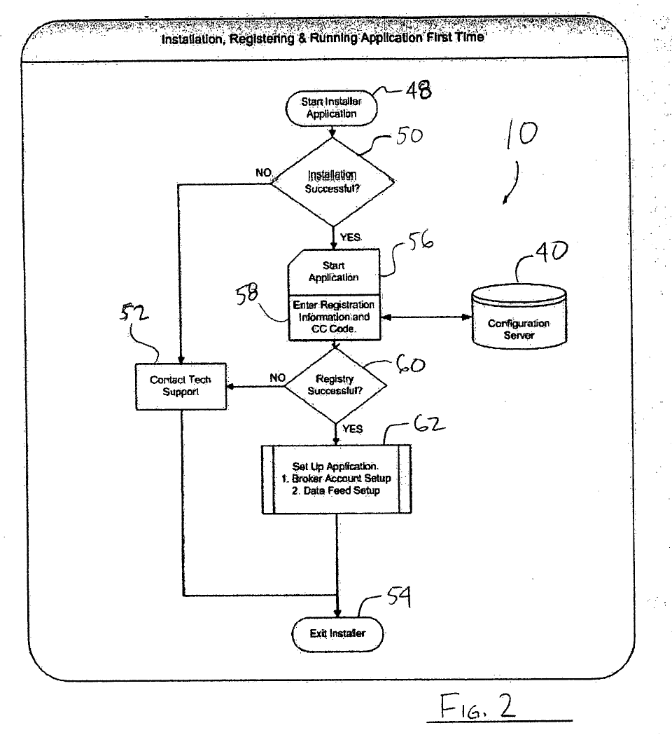

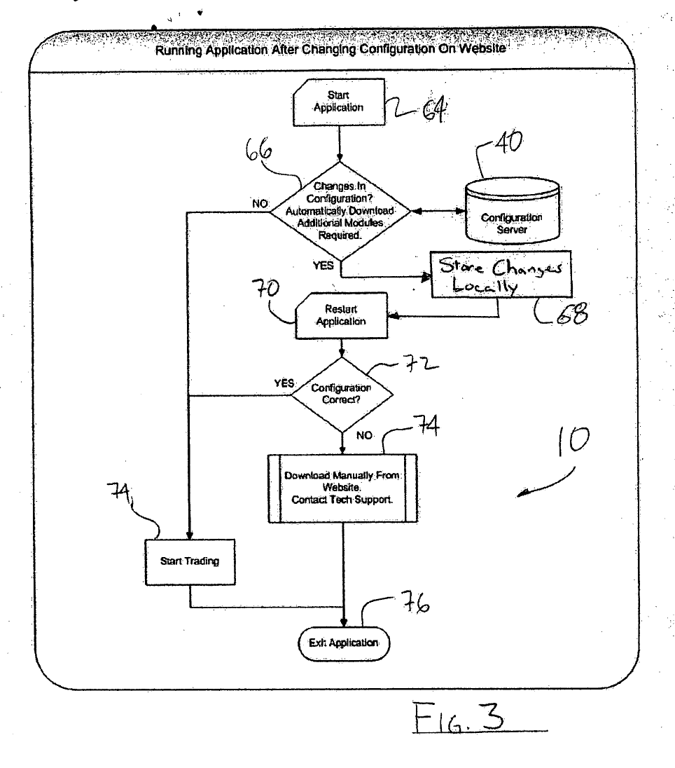

Referring to FIGS. 1 through 3, a method for a client subscriber to subscribe to a portion of a plurality of software modules is generally indicated at 10. For purposes of this discussion, the inventive method has been parsed into three general functions, each of which is represented by an individual figure. In FIG. 1, the method 10 relates to website registration and product configuration. In FIG. 2, the portion of the method shown relates to the installation, registering and running of the application for the first time, and in FIG. 3, this portion of the method relates to running the application after changing the configuration on the website. The method 10 allows a user the ability to modify his or her subscription at any time where the change in the subscription will take affect in real time. In addition, the method 10 allows the updates to the subscription to occur such that the updates to the subscription and any work performed on the subscription (discussed in greater detail subsequently) will be stored in a manner sufficient to allow the user to access the work and work from the modified subscription of software from any location in which the user has installed the software. Therefore, it is contemplated that the user may include in the subscription a plurality of seats where the subscription software may be accessed.

The software may be any software product available. The software is designed to have portions of it resident on a server computer and portions resident on a client computer. A client subscriber is a subscriber that is located at a client computer. A client subscriber may be an individual or an organization. The software accessed by the client subscriber allows the client subscriber to perform any number of tasks. As the requirements for the software changes for the client subscriber, the client subscriber may modify its subscription to the software by selecting different software modules that may provide the services required by the client subscriber. When the client subscriber changes its subscription for the software, it will be able to add and/or subtract various software modules from its subscription after which it will have the ability to access a different set of software modules. The inventive method 10 allows the client subscriber to do so in a manner that will allow the subscription to be updated immediately so that any client subscriber that logs onto the software will see the new subscription and, hence software configuration, immediately after the subscription has been changed by the client subscriber.

Referring back to FIG. 1, the method begins with the client subscriber logging in at 12. The client subscriber is identified at 14. If the client subscriber is not a new user, the client subscriber is logged in with the user name and password at 16. The product configuration is updated at 18. When the product configuration is updated, the method identifies which software modules are associated with the client subscriber. Given there are a plurality of software modules, a portion of those are associated with the client subscriber to which the client subscriber has access. It should be appreciated by those skilled in the art that the portion of the plurality of software modules associated with any particular client subscriber may be a single software module or may be the complete set of software available through the method. Once updated, the client subscriber or user is asked to accept the user license at 20. Billing information is updated at 22.

If the user is a new user, the method moves from identifying the client subscriber at 14 to a register and sign up action at 24. The client subscriber then provides the billing information at 26 and selects products and modules at 28. The method then requests acceptance by the client subscriber of the user license at 30.

Regardless of whether the client subscriber is new or not, changes to the subscription are confirmed at 32. If the changes are not confirmed, the method returns to step 18 where the portion of the plurality of software modules is updated. If the changes in the subscription of software modules is confirmed at 32, payment is processed at 34 allowing the client subscriber to pay for the new configuration of software modules. Depending on the new portion of software modules that the client subscriber has chosen, the payment may be an increase or a decrease from a prior month's subscription rate if the client subscriber is not new. It is then determined at 36 whether the payment is successful. If not, the method returns to step 22 where billing information is updated. If the payment is successful, the method then continues to the process of associating each of the modules that have been ordered by the client subscriber with the subscription for the client subscriber.

Once the client subscriber has transmitted its selections for the portion of the plurality of software modules to the server computer, each of the portion of plurality of software modules are tagged at 38. This correlates the portion of plurality of software modules to the client subscriber. The tagged software modules associated with the client subscriber are stored, graphically represented by the configuration server 40. The process of tagging each of the plurality of software modules to correlate the portion of the plurality of software modules to the client subscriber includes the generation of an XML tag for the new configuration. Once the XML tag is created, a configuration code is created. The software then creates a download link on the web to update the configuration server 40. The method then creates “My Account” pages allowing the client subscriber the ability to see its configuration in a user friendly format.

It is then determined at 42 whether the download for the client subscriber is the first one made by the client subscriber. If so, the user download and installation of the application is made on the client or local machine at 44. If not, the user logs out of the registration and product configuration portion of the method 10 at 46.

Referring specifically to FIG. 2, this portion of the method 10 relates to the installation, registering and running of the application for the first time. This portion of the method 10 begins at 48 at the start of the installer application. Immediately, it is determined whether the installation was successful at 50. If not, technical support is contacted at 52 and the installer application is exited at 54. If the installation was successful at 50, the application is started at 56. The registration information and configuration code are provided at 58. Bilateral communication between the configuration server 40 at this point enables the client subscriber the opportunity to utilize the application in the form in which it was ordered through the product configuration of FIG. 1. It is then determined whether the registration process was successful at 60. If not, technical support is again contacted at 52 and the installation portion of the application is terminated at 54. If the registry is successful, the portion of the plurality of software modules is then copied to the client subscriber at 62. The copying of the portion of the plurality of software modules includes the set up application, the broker account set up and data feed set up in the embodiment shown which relates to the financial markets. Upon completion of the set up application, the installer portion of the method 10 is exited at 54.

Referring specifically to FIG. 3, this portion of the method 10 depicts how the application run after changing the configuration on the website at the server computer. The application starts at 64. It is then determined at 66 whether changes in the configuration have occurred. The application automatically downloads the portion of the plurality of software modules to the client subscriber. This is done in communication with the configuration server 40. If there were in fact changes in the configuration, i.e., changes to the portion of the software modules that have been tagged by the client subscriber, those changes are stored locally at 68. When they are stored locally, they are stored locally whenever the client subscriber logs on to a client computer within which the application has been loaded. This allows the configuration to be utilized should the client subscriber choose to work remotely offline for a period of time for whatever reason. Once the changes are stored locally, the application is restarted at 70. It is then determined if the configuration is correct at 72. If so, trading commences at 74 if the application being utilized is a software package that allows entities to trade securities and commodities. Once the activity is completed, the application is exited at 76.

If, at 66, there were no changes in the configuration, the client subscriber can then immediately start the activity of the application at 74. If the configuration is determined to be incorrect at 72, the client subscriber has the opportunity to download manually the configuration at 74. In addition, technical support is contacted at that time to trouble shoot why the configuration did not correctly load.

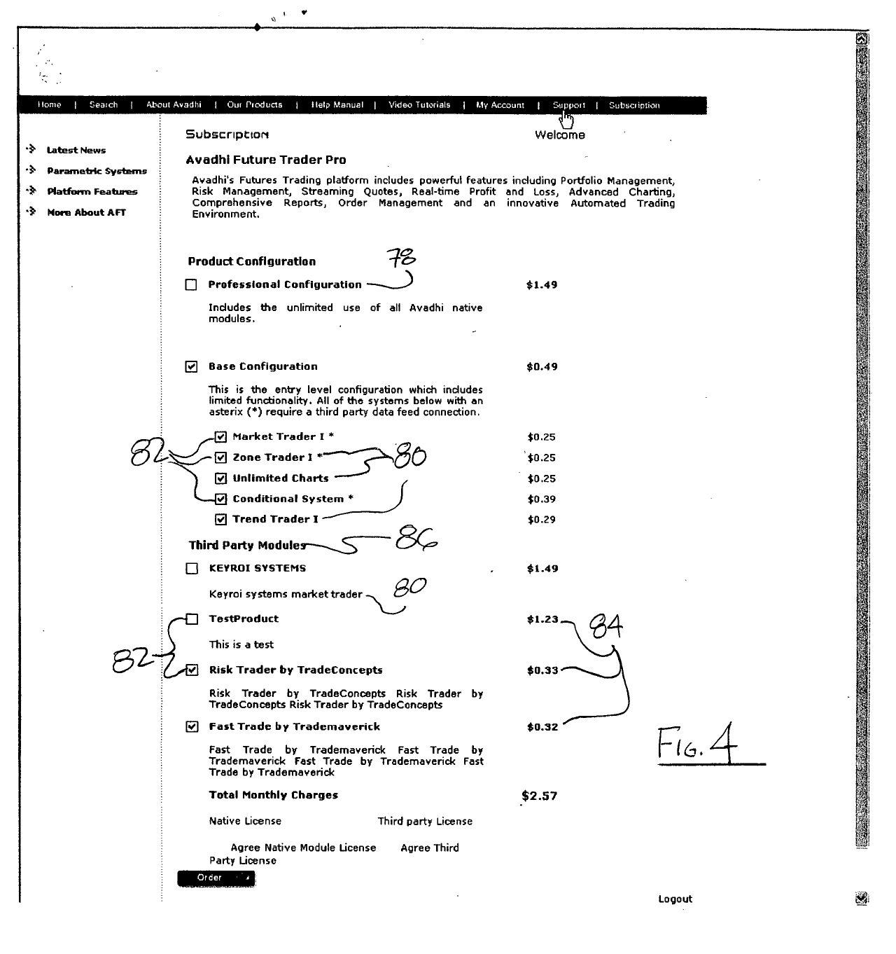

Referring to FIG. 4, a typical screen shot of the inventive method as it displays a summary of selections made by a user. The product name is identified at 78. The name of the modules that have been made a part of the subscription are identified at 80. Check boxes 82 allows the subscriber the opportunity to select and deselect modules of software 80. A cost window 84 identifies how much the module will cost. While it is contemplated that the cost is based on a monthly rate, any rate may be used to affect the business model of any desire.

As may be seen, the system contemplates the incorporation of third party software through its inclusion of third party modules, graphically identified by subtitle at 86. As more third party modules 86 are included in an offering for sale, the more attractive the method is because the method will have more capabilities and functionality as a result of more individuals and entities preparing software to be utilized by the method.

It is contemplated that the modules will be designed able to operate with a plurality of operating systems. Therefore, the operating system will be identified with the module so that the operation of the module will work.

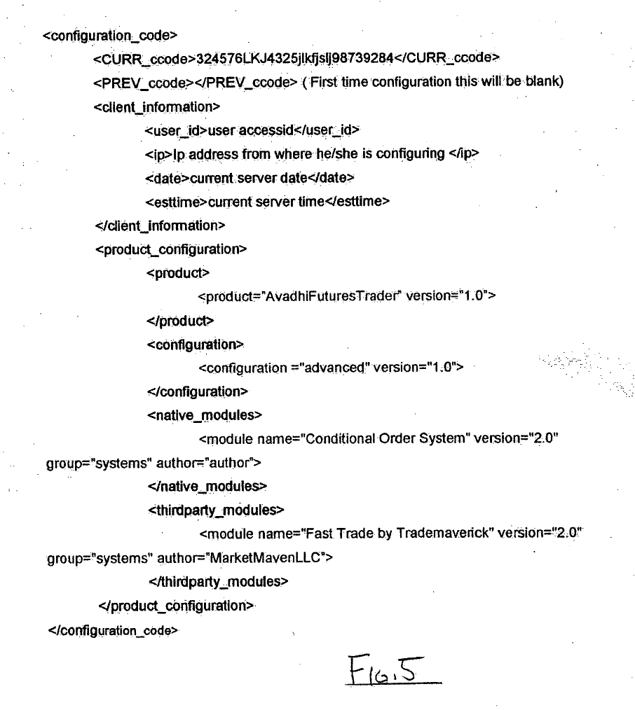

Referring to FIG. 5, an example of a block of XML code is shown which is used to identify client information, product information, modules of the application that are created with the application and third party modules which are created by third parties to be incorporated into the application after the application has been made available. The benefit of such an open system is the ability to have conceivably an infinite number of modules made available to any client subscriber.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for subscribing to a portion of a plurality of software modules allowing a subscriber to have access to the portion of the plurality of software modules, the method comprising the steps of:
identifying the subscriber;
providing the plurality of software modules to the subscriber;
receiving selections from the subscriber;
associating each of the selections with the portion of the plurality of software modules;
tagging each of the portion of the plurality of software modules with a tag to correlate the portion of the plurality of software modules to the subscriber; and
storing the tags such that the subscriber can access the portion of the plurality of software modules when desired.

2. A method for a client subscriber to subscribe to a portion of a plurality of software modules stored on a server computer allowing the subscriber to have access to the portion of the plurality of software modules client side, the method comprising the steps of:
identifying the client subscriber;
providing the plurality of software modules to the client subscriber from the server computer;
receiving selections from the client subscriber;
associating each of the selections with the portion of the plurality of software modules;
tagging each of the portion of the plurality of software modules with a tag to correlate the portion of the plurality of software modules to the client subscriber; and
storing the tags such that the client subscriber can access the portion of the plurality of software modules resident on the server computer when the client subscriber is identified.

3. A method as set forth in claim 2 including the step of transmitting the portion of the plurality of software modules to the client subscriber.

4. A method as set forth in claim 3 including the step of copying the portion of the plurality of software modules at the client subscriber.

5. A method as set forth in claim 4 including the step of allowing the client subscriber to operate the portion of the plurality of software modules to perform work.

6. A method as set forth in claim 5 including the step of storing the work at the client subscriber.

7. A method as set forth in claim 6 including the step of synchronizing the work stored at the client subscriber to the server computer when the client subscriber is terminating its connection with the server computer.

8. A method as set forth in claim 7 including the step of setting a number of seats at which the client subscriber may interact with the server computer.

9. A method as set forth in claim 8 including the step of providing the software modules for download to at a number of auxiliary client subscribers associated the client subscriber equal to the number of seats.

10. A method as set forth in claim 9 including the step of synchronizing the portion of software modules and the work at each of the auxiliary client subscribers.

11. A method as set forth in claim 10 wherein the step of tagging includes the step of generating a code in extensible markup language to associate on of the plurality of software modules with the client subscriber.

12. A method as set forth in claim 11 including the step of generating a code in extensible markup language for each of the portion of plurality of software modules associated with the client subscriber.

13. A method as set in claim 12 including the step of storing the codes associated with the client subscriber allowing the client subscriber to periodically access the portion of the plurality of software modules.

14. A method as set forth in claim 13 including the step of requiring payment from the client subscriber for each of the portion of software modules tagged thereto.

15. A method as set forth in claim 14 including the step of limiting the step of requiring payment only to the time in which each of the portion of software modules is tagged to the client subscriber.

16. A method for a client subscriber to subscribe to a portion of a plurality of software modules stored on a server computer allowing the subscriber to have access to the portion of the plurality of software modules client side, the method comprising the steps of:
identifying the client subscriber;
providing the plurality of software modules to the client subscriber from the server computer;
receiving selections from the client subscriber;
associating each of the selections with the portion of the plurality of software modules;
tagging each of the portion of the plurality of software modules with a tag to correlate the portion of the plurality of software modules to the client subscriber;
storing the tags such that the client subscriber can access the portion of the plurality of software modules resident on the server computer when the client subscriber is identified; and
requiring payment from the client subscriber for each of the portion of software modules tagged thereto.

17. A method as set forth in claim 16 including the step of transmitting the portion of the plurality of software modules to the client subscriber.

18. A method as set forth in claim 17 including the step of copying the portion of the plurality of software modules at the client subscriber.

19. A method as set forth in claim 18 including the step of allowing the client subscriber to operate the portion of the plurality of software modules to perform work.

20. A method as set forth in claim 19 including the step of storing the work at the client subscriber.

21. A method as set forth in claim 20 including the step of synchronizing the work stored at the client subscriber to the server computer when the client subscriber is terminating its connection with the server computer.

22. A method as set forth in claim 21 including the step of setting a number of seats at which the client subscriber may interact with the server computer.

23. A method as set forth in claim 22 including the step of providing the software modules for download to at a number of auxiliary client subscribers associated the client subscriber equal to the number of seats.

24. A method as set forth in claim 23 including the step of synchronizing the portion of software modules and the work at each of the auxiliary client subscribers.
